(19) United States
(12) Patent Application Publication
(10) Pub. No.: US 2015/0081382 A1
(43) Pub. Date: Mar. 19, 2015

(54) CUSTOMER RELATIONSHIP ACCOUNT AUGMENTATION BASED ON WIRELESS DETECTION OF MOBILE DEVICES, WITH PERSONALIZED MESSAGING

(71) Applicants: ISRAEL L'HEUREUX, MONACO (MC); MARK D. ALLEMAN, PORTLAND, OR (US)

(72) Inventors: ISRAEL L'HEUREUX, MONACO (MC); MARK D. ALLEMAN, PORTLAND, OR (US)

(21) Appl. No.: 14/459,236

(22) Filed: Aug. 13, 2014

Related U.S. Application Data
(60) Provisional application No. 61/865,278, filed on Aug. 13, 2013.

(51) Int. Cl. G06Q 30/02; H04W 24/08; G06Q 30/00

(52) U.S. Cl. CPC G06Q 30/0281; G06Q 30/016; H04W 24/08; G06Q 30/0201
USPC 705/7.29

(57) ABSTRACT

A customer relationship system includes a local computing system located on-premises of a public accommodation and a remote computing system that communicates with the local computing system. The local computing system includes or interfaces with a wireless access point that provides a wireless communications network to the public accommodation. The local computing system validates that a target wireless communication device associated with a target MAC address or hardware identifier of the one or more identified MAC addresses or hardware identifiers is present at the public accommodation by matching an on-premises characteristic of the detected beacon frames transmitted by wireless communication devices. The remote computing system augments a visit counter based upon a message received from the local computing system, and transmits a personalized message to the wireless communication device in which the personalized message is programmatically modified based upon a value of the visit counter.

### CROSS-REFERENCE TO RELATED APPLICATIONS

The present application claims priority to and is a non-provisional of U.S. provisional application Ser. No. 61/865,278, titled CUSTOMER RELATIONSHIP ACCOUNT AUGMENTATION BASED ON WIRELESS DETECTION OF MOBILE DEVICES, WITH PERSONALIZED MESSAGING, filed Aug. 13, 2013, the entire contents of which is incorporated herein by reference in its entirety for all purposes.

### BACKGROUND

In recent years, the widespread adoption of wireless communication devices by members of the general public has caused many public accommodations to provide wireless Internet connectivity through on-premises wireless access points. For example, many retail establishments and public venues currently offer complimentary Wi-Fi access to their customers or invitees. At the same time, members of the general public have become accustomed to purchasing goods and services over the Internet from trusted e-commerce platforms. These e-commerce platforms typically maintain a user profile for each customer that contains past purchasing activity information, financial transaction information, and other personal information.

### SUMMARY

In one aspect of the disclosed subject matter, a customer relationship system includes a local computing system located on-premises of a public accommodation and a remote computing system that communicates with the local computing system via a communications network. The local computing system includes or interfaces with a wireless access point device that provides a wireless communications network covering at least a portion of the public accommodation.

The local computing system detects, via the wireless access point, beacon frames wirelessly transmitted by one or more wireless communication devices, and extracts or otherwise identifies one or more identifiers of the one or more wireless communication devices from the beacon frames originating therefrom. The local computing system validates that an individual or target wireless communication device associated with an identifier is present at the public accommodation by matching an on-premises characteristic of the detected beacon frames. The local computing system transmits a message directed to the remote computing system via the communications network. The message indicates that the target wireless communication device has been detected via the wireless access point and validated as matching the on-premises characteristic of the detected beacon frames.

The remote computing system maintains a customer relationship record for the target wireless communication device. The customer relationship record of the target wireless communication device includes a visit counter for the local computing system located at the public accommodation. The remote computing system augments the visit counter based upon the message received from the local computing system, and stores the augmented visit counter in the customer relationship record. The remote computing system transmits a personalized message to the wireless communication device in which the personalized message is programmatically modified based upon a value of the visit counter, either before or after augmentation.

It will be appreciated that this Summary describes only some of the concepts covered in greater detail in the following Detailed Description and associated drawings. As such, claimed subject matter is not limited to the contents of this Summary.

### BRIEF DESCRIPTION OF DRAWINGS

FIG. 1 is a schematic diagram depicting an example customer relationship system.

FIG. 2 is a flow diagram depicting an example method for a customer relationship system.

FIG. 3 is a flow diagram depicting another example method for a customer relationship system.

FIGS. 4-6 depict example personalized messages in graphical form.

FIG. 7 depicts an example user interface that enables a user to opt-in to receiving personalized messages.

FIG. 8 is a schematic diagram depicting an example computing system or computing device.

FIG. 9 is a schematic diagram depicting example data records that may be contained in an example database system.

FIG. 10 is a flow diagram depicting an example method of applying rule sets to generate personalized information.

### DETAILED DESCRIPTION

A customer relationship system is disclosed that uses beacon frames wirelessly transmitted by wireless communication devices to sense the presence of customers associated with those wireless communication devices at a public accommodation. A customer relationship record is maintained for each wireless communication device and/or customer that contains a visit counter. The visit counter is updated responsive to or based on a customer visiting the public accommodation with a wireless communication device. Personalized messages are wirelessly communicated to the wireless communication devices that are present at the public accommodations based on the respective visit counters attributed to the wireless communication devices. The customer relationship system may be implemented within the context of an individual public accommodation and/or across many different public accommodations sited at geographically diverse locations.

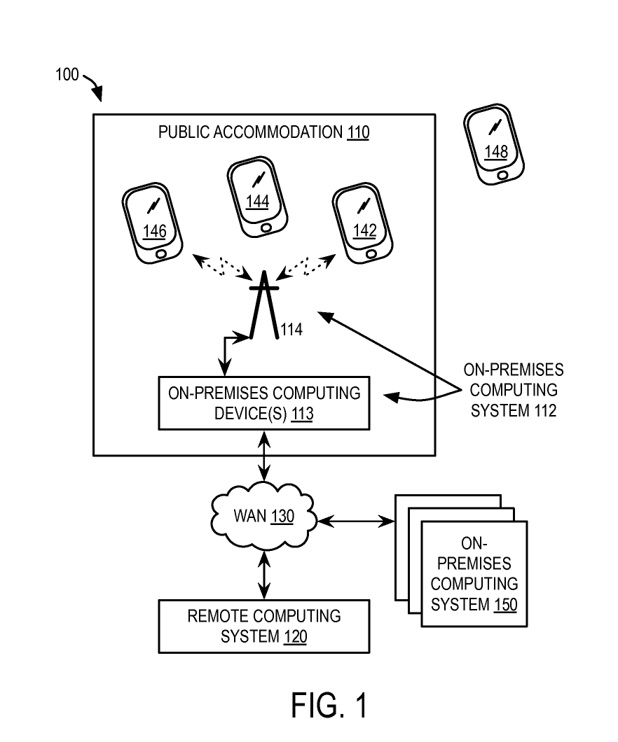

FIG. 1 is a schematic diagram depicting an example customer relationship system 100. Customer relationship system 100 includes an on-premises computing system 112 located at or on-premises of a public accommodation 110. On-premises computing system 112 may be referred to as a local computing system, since on-premises computing system 112 resides locally at the premises of the public accommodation.

In one example, public accommodation 110 may take the form of a retail establishment through which products and/or services are available for purchase by customers. Non-limiting examples of such products or services include a food or beverage service location such as a restaurant or bar, a grocery store, or other suitable commercial business accommodations having a physical premises. In another example, public accommodation 110 may take the form of a public space or venue, such as a museum, ballpark, recreational park, airport, etc. It will be understood that public accommodation 110 may not be defined by physical walls or structures in some use-scenarios, such as may be the case with outdoor venues.

On-premises computing system 112 includes one or more on-premises computing device(s) 113. An on-premises computing device may include a server computer, a personal computer, a networking device, or a computing device integrated with a wireless access point, to name a few non-limiting examples.

On-premises computing system 112 further includes or otherwise interfaces with one or more wireless access point devices (referred to simply as a wireless access point or WAP). FIG. 1 depicts example on-premises computing system 112 including or interfacing with an example WAP 114 located on-premises of public accommodation 110. WAP 114 serves the public accommodation 110 by providing a wireless communications network that covers at least a portion of the premises of the public accommodation.

In FIG. 1, WAP 114 defines an edge of a wireless network with one or more wireless communication devices, such as 142, 144, 146, 148, etc. On-premises computing device(s) 113 may communicate with wireless communication devices 142-148 via WAP 114. As a non-limiting example, a uni-directional or bi-directional wireless communications link between WAP 114 and each wireless communication device may take the form of a Wi-Fi (802.11) compliant wireless link. However, other suitable wireless communications protocols may be used.

Communications between WAP 114 and on-premises computing device(s) 113 may be over a wired or wireless communications link. In one example, WAP 114 obtains wide area network (WAN) connectivity or access to WAN 130 via one or more of on-premises computing device(s) 113. In this context, one or more of computing device(s) 113 may include one or more of a network routing device, network switching device, network appliance, network gateway, etc. In another example, on-premises computing device(s) 113 obtain WAN connectivity or access to WAN 130 via WAP 114. WAN connectivity or access to WAN 130 by on-premises computing system 112 may include wired and/or wireless communications links. In an example implementation, wireless communication devices (e.g., 142, 144, etc.) may obtain Internet connectivity with WAN 130 via WAP 114 and/or other computing devices of on-premises computing system 113. The wireless edge of this Internet connectivity may be in the form of free public Wi-Fi or free Wi-Fi offered to patrons of the public accommodation.

WAP 114 and on-premises computing device(s) 113 may take the form of a common integrated device in some examples, or may alternatively take the form of two or more distinct devices in other examples.

On-premises computing system 112 and its WAPs (e.g., WAP 114) may communicate with remote network resources, such as a remote computing system 120 via WAN 130. WAN 130 may include or take the form of the Internet (or a portion thereof), and may include cellular/wireless WAN components or edge sub-networks. In at least some implementations, a customer relationship system formed by or from a local computing system and/or a remote computing system may be configured to send or exchange heartbeat transmissions with each other at a rate or frequency that is between once every 10 seconds and once every 1 minute. However, other suitable time rates, frequencies, or time periods may be used.

Remote computing system 120 includes one or more computing devices, such as one or more server devices forming a server system, for example. Remote computing system 120 may include or may be referred to herein as a customer relationship server or server system, or a relationship server or relationship server system. Remote computing system 120 may communicate with and/or provide services to other on-premises computing systems in addition to example computing system 112, each of which may be located at and serve a different premises of a different respective public accommodation. For example, FIG. 1 depicts example on-premises computing system 150, which may be located at and serve a public accommodation that is geographically remote from public accommodation 110.

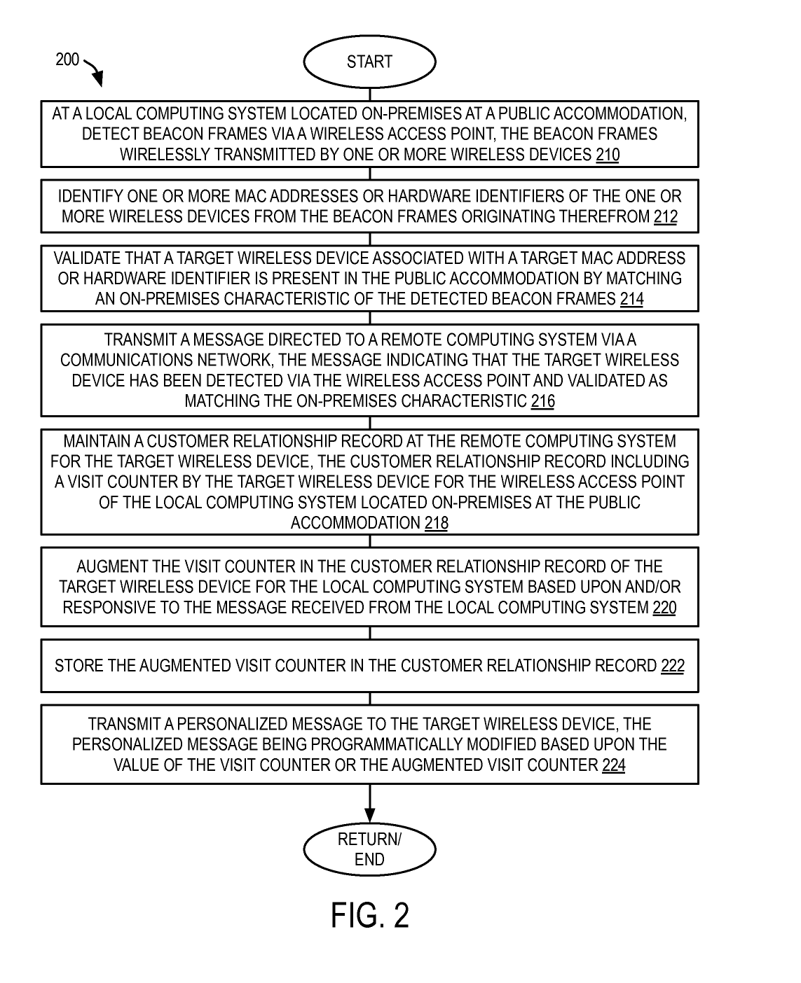

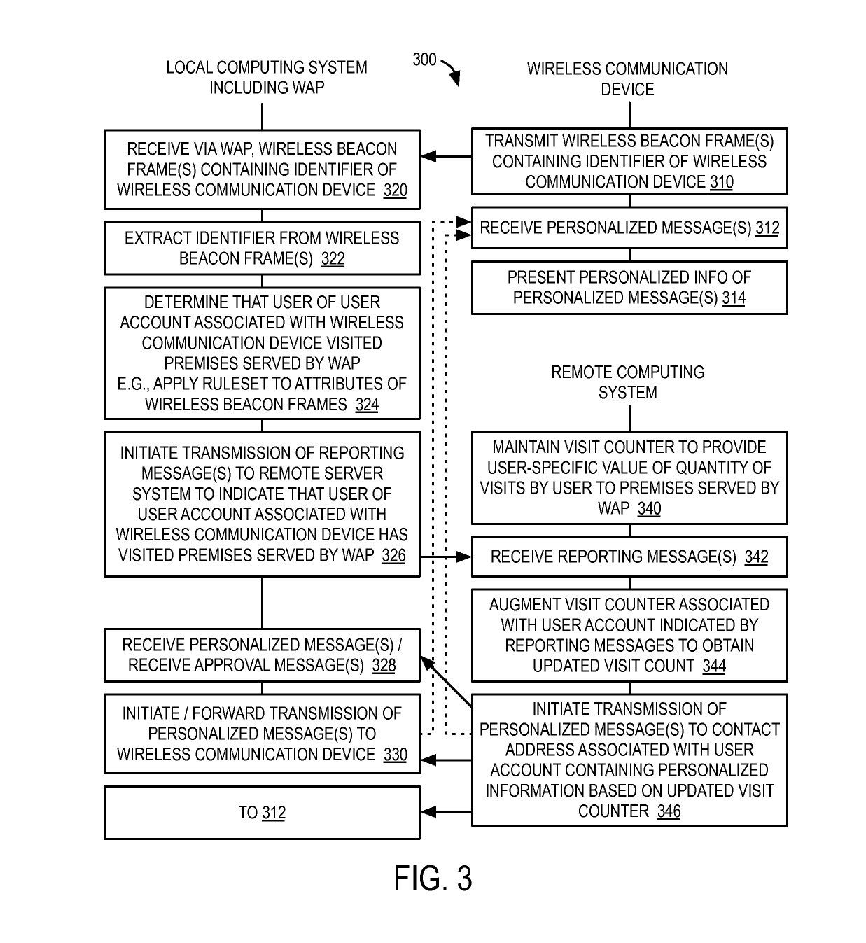

As schematically depicted in FIG. 1, some of the wireless communication devices (e.g., 142, 144, and 146) are located at or within public accommodation 110, while another wireless communication device (e.g., wireless communication device 148) is located outside of public accommodation 110. On-premises computing system 112 and its WAPs in combination with remote computing system 120 identify whether individual or target wireless communication devices are located at or within the public accommodation. If a wireless communication device is determined to be sufficiently present at or on-premises of the public accommodation, one or more personalized messages containing personalized information may be transmitted to that wireless communication device. This determination and transmission of personalized messages may be performed by on-premises computing system 112, remote computing system 120, or a combination thereof, depending on implementation. In at least some implementations, the personalized information of the one or more personalized messages may be based, at least in part, upon a value of a visit counter associated with the wireless communication device and/or a user account of a user of the wireless communication device. Further aspects of this personalized messaging is described in greater detail with reference to FIGS. 2 and 3.

FIG. 2 is a flow diagram depicting an example method for a customer relationship system. Aspects of this method may be performed by and through cooperation of a local computing system located on-premises of a public accommodation and its WAP (e.g., on-premises computing system 112 of FIG. 1), and a remote computing system (e.g., remote computing system 120 of FIG. 1) communicating with the local computing system and its WAP via a communications network (e.g., WAN 130 of FIG. 1).

Many visitors to a public accommodation, whether intentional or passerby, often arrive carrying a wireless communication device, such as a mobile smart phone, portable laptop or tablet computer, wearable communication device such as a wristwatch or glasses, etc. An on-premises computing system (i.e., local computing system) located at and serving a premises of the public accommodation receives, via its WAP, wireless beacon frames transmitted by wireless communication devices carried by visitors to the public accommodation.

Each of these wireless beacon frames contains an identifier of the wireless communication device that transmitted the beacon frame. In one example, the wireless communication devices may communicate with the WAP over a wireless link using the Wi-Fi (802.11) protocol or other suitable wireless protocol. In such case, the identifier of the wireless communication device may take the form of a media access control (MAC) address, for example. However, other suitable identifiers may be utilized.

Within at least some wireless networks (e.g., Wi-Fi/802.11), beacon frames are periodically transmitted by each wireless communication device to announce the presence of that wireless communication device. Beacon frames typically include a MAC header, a frame body, and FCS. The MAC header contains the MAC address. Each wireless communication device is uniquely identified by a respective MAC address. The MAC address may be extracted or otherwise read from the MAC header to identify the wireless communication device. In some contexts, the MAC address takes the form of a service set identifier (SSID), which may include or may be based on a hardware identifier of the wireless communication device. At times, the SSID may be chosen by the wireless communication device that initiates communications over the network. The broadcasting of the SSID is typically performed in a pseudo-random order by all wireless communication devices that are members of the network. A beacon interval refers to the time between beacon frame transmissions by a wireless communication device. The beacon interval is expressed in terms of a Time Unit (TU), which is a configurable parameter. Typically the beacon interval is configured at 100 TU, however, other suitable values may be used.

The identifier of the wireless communication device may be extracted from the one or more wireless beacon frames that are received by the local computing system. For example, at 212, the method includes, identifying one or more MAC addresses or hardware identifiers of the one or more wireless communication devices from the beacon frames originating therefrom. In at least some implementations, operation 212 may be performed by the local computing system or its WAP. For example, operation 212 may be performed by a WAP that forms part of or interfaces with the local computing system.

At 214, the method includes, validating that an individual or target wireless communication device associated with the identifier is present at the public accommodation. Validating in this context may include matching an on-premises characteristic of the detected wireless beacon frames. In at least some implementations, operation 214 may be performed by the local computing system or its WAP. In other implementations, operation 214 may be performed by the remote computing system through one or more messages exchanged with (e.g., received from and reported to) the local computing system.

In an example implementation, the on-premises characteristic may be implemented by applying a rule set to attributes of the wireless beacon frames. Collectively, the rule set and attributes may be referred to as the presence criteria. In this context, the method at 214 may include, applying a rule set to one or more attributes of the one or more wireless beacon frames to, upon satisfaction of one or more rules of the rule set, determine that a user of a user account associated with the wireless communication device has visited a premises of a public accommodation served by the WAP. Satisfaction of one or more predefined rules of a rule set results in validation of the presence of the wireless communication device and hence its user at a premises of a public accommodation.

In a non-limiting example, the one or more attributes may include signal strength of the one or more wireless beacon frames and/or quantity of the one or more wireless beacon frames received within a time period. As further non-limiting examples, the one or more rules of the rule set may be satisfied if: (1) the signal strength attains or exceeds a first signal strength threshold, and/or (2) the signal strength attains or exceeds a second signal strength threshold for at least a first threshold time period, and/or (3) the signal strength is substantially constant for at least a second threshold time period, and/or (4) the quantity of the one or more wireless beacon frames received within the time period attains or exceeds a threshold quantity of beacon frames.

These one or more rules (or other suitable rules) may be applied alone or in any suitable combination to attributes of one or more wireless beacon frames containing a particular identifier. The above rules may be applied on an individual identifier basis (i.e., for each instance of the same identifier) to determine whether a wireless communication device identified by that individual identifier is sufficiently present at a premises to result in validation. In the above examples, the thresholds designated as first, second, third, etc. may be identical to each other may be lower or higher thresholds in relation to each other, depending on implementation. Any suitable threshold or filtering criteria may be used to validate or exclude wireless communication devices and their users from being considered present at a premises by the customer relationship system.

It will be appreciated that other suitable filters, criteria, rules, conditions, etc. may be used to determine whether a wireless communication device exhibits merely a transitory presence within a wireless network range of a WAP (e.g., carried by a passenger of a vehicle or a pedestrian passing through or near the area) or whether the wireless communication device was sufficiently present to warrant validation (e.g., resulting in the provision of a personalized message to that wireless communication device). It will be appreciated that filters, criteria, rules, conditions, etc. for validating presence may be configurable by a system administrator globally across all accommodations, globally across all premises of a chain of public accommodations, globally across all WAPs of a particular premises, or individually to provide premises-specific or WAP-specific validation criteria, to thereby provide a suitable level of validation responsiveness for virtually any scenario.

At 216, the method includes, transmitting a message from the local computing system directed to a remote computing system via a communications network. The message indicates that the target wireless communication device has been detected via the wireless access point and validated as matching the on-premises characteristic. The message may include the MAC address or hardware identifier, or may include a different identifier that is associated with the MAC address or hardware identifier at the local computing system. The message may additionally include an identifier for the local computing system and/or the public accommodation with which it is associated.

At 218, the method includes, at the remote computing system, maintaining a customer relationship record for the target wireless communication device. In at least some implementations, a customer may establish a customer relationship record at the remote computing system by signing up for a customer loyalty service via an Internet web portal, website, or other suitable network interface. A sign-up process may include a customer providing his or her name, their MAC address or hardware identifier, and/or other suitable information, such as financial transaction information (e.g., credit card/depict card number, billing address, etc.), biographical information, user settings, etc.

In some implementations, the local computing system or the remote computing system may detect the MAC address or hardware identifier used by the customer for the communications device that is used to initially establish the customer relationship record, and may thereby associate that MAC address or hardware identifier with the customer relationship record. In some implementations, the local computing system or the remote computing system may detect each MAC address or hardware identifier used by the customer when logging into a customer loyalty service to access the customer relationship record, and may associate each of those MAC addresses or hardware identifiers with the customer relationship record.

A customer relationship record (also referred to as a user account) may further include a visit counter for premises (e.g., each local computing system located on-premises at a respective public accommodation) and/or for each chain of related group of public accommodations. In at least some implementations, a visit counter may form part of a broader user account value. The user account value may define an aggregation of the visit counter with one or more other customer activity values. Such customer activity values may include a purchase counter, a purchase value, a purchase frequency, a visitor frequency, a survey response counter, a survey response frequency, or other quantifiable forms of customer activity. One or more of these customer activity parameters may be used to programmatically generate personalized information in the form of one or more personalized messages, including an account balance and/or available rewards for the customer. The account balance and/or available rewards values may be stored in the customer relationship record of each customer.

At 220, the method includes, augmenting the visit counter in the customer relationship record of the target wireless communication device for the local computing system based upon the message received from the local computing system. For example, responsive to a third instance of a MAC address or hardware identifier being detected as being present at the public accommodation and validated, the visit counter may be incremented to a “3” to reflect the third visit to the accommodation.

It will be appreciated that individual instances of presence may be distinguished using any suitable filter, including time-based filters. For example, individual instances of presence may be distinguished from each other using a second, a minute, an hour, a day, a week, a month, a year, etc. as a filter. In such case, a persistent presence of a wireless communication device within that time-based filter period may be considered by the local and/or remote computing system as being a single visit. For example, a customer remaining on-premises of a public accommodation for an entire day may receive only a single visit counter update if the filter is set to a day or longer, whereas a customer remaining on-premises for three hours may receive three visit updates if the filter is set to an hour or less. This filtering tool may also be used by administrators to limit a particular visit counter to a maximum number of updates per time period even in the context of non-persistent presence of the customer. For example, a visit counter for a public accommodation may be updated only once per day even if a customer shops at the public accommodation multiple times in the same day. Such filtering may be implemented at or by the local computing system and/or the remote computing system, and may be responsive to administrator-defined filter criteria.

At 222, the method includes, storing the augmented visit counter in the customer relationship record as an updated visit counter. At 224, the method includes, transmitting a personalized message to the target wireless communication device. The personalized message may be generated and/or programmatically modified based upon the value of the visit counter, whether prior to being augmented or after being augmented (e.g., the updated visit counter) at operations 220/222.

The personalized message may be transmitted to the wireless communication device by the remote computing system sending the personalized message to the local computing system or by instructing the local computing system to transmit the personalized message, which in turn constructs and/or forwards the personalized message to the wireless communication device via the wireless access point. In another example, the remote computing system may bypass the local computing system by transmitting the personalized message to the wireless communication device over a different wireless network, such as a wide area cellular network. The wireless communication device receives the personalized message and presents the personalized message to the customer, such as via a graphical display.

The personalized message may take virtually any suitable form. Non-limiting examples include SMS text messages, email messages, proprietary messages associated with a special purpose application program operating at the wireless communication device, or web content information that is rendered by a general purpose browser program operating at the wireless communication device. The web content information may be presented as part of a captive web portal initiated by the local computing system and/or its WAP at the time that the wireless communication device attempts to obtain web connectivity via the WAP.

The personalized message delivered responsive to presence detected at a given premises may include personalized information that is based, at least in part, on the on a value of the visit counter for that premises or a chain that includes that premises. As one example, the personalized message may include availability of a product or service in the public accommodation frequented most often by the customer (i.e., user) according to data contained in the customer relationship record. As another example, the personalized message may include a summary of a customer relationship account status, including account balances and available rewards. As another example, the personalized message may include a link to access an order history of the customer. In yet another example, the personalized message may include a suggested order for the customer. In such case, the suggested order may be based upon one or more of an (1) order history contained in the customer relationship record, (2) express preferences contained in the customer relationship record, (3) actual sales of goods and services at the public accommodation contained in a public accommodation record maintained by the remote computing system. The personalized message may include a link to an ordering tool that enables a customer to place an order for goods or services.

In some implementations, the local computing system and/or the remote computing system may receive GPS or other suitable geo-location data indicating a detected location of the wireless communication device. Alternatively or additionally, the remote computing system may retrieve geo-location information associated with the local computing system to obtain an approximate location of the wireless communication device detected by that local computing system. The personalized message may include information relating to a product or service in a public accommodation that is nearby the location of the wireless communication device or the local computing system. Hence, the personal message may include content related to the public accommodation or other nearby public accommodations.

In at least some implementations, orders placed by a customer at the wireless communication device or at a point of sale system (e.g., of the local computing system) of the public accommodation may be received by the local computing system, and may be forwarded to the remote computing system. The remote computing system may maintain and update customer relationship records and/or public accommodation records responsive to and based on completed orders or transactions.

As previously described with reference to FIG. 1, a WAP may be one of a plurality of WAPs of a local computing system serving a public accommodation. Through implementation of the method 200 of FIG. 2 (and/or method 300 of FIG. 3), each WAP may be configured to (1) detect a plurality of beacon frames transmitted by each of a plurality of wireless communication devices, (2) identify MAC addresses or hardware identifiers of each of the wireless communication devices from the beacon frames originating therefrom, (3) validate that one of the (i.e., a target) wireless communication devices associated with one of the (i.e., a target) MAC addresses or hardware identifiers was present at the respective public accommodation associated with the WAP by matching an on-premises characteristic, and (4) transmit a message to the relationship server via the computer network indicating the wireless communication device was detected at the wireless access point and validated as matching the on-premises characteristic. In this implementation, the visit counter in the customer relationship record for the wireless communication device may be one of a plurality of visit counters. Each visit counter counts visits to a respective one of the WAPs at a corresponding public accommodation. In such implementations, the personal message may be programmatically modified based upon the value of the target visit counter (e.g., prior to or after augmentation) and other visit counters in the customer relationship record for other public accommodations.

FIG. 3 is a flow diagram depicting an example method 300. Method 300 may refer to a non-limiting example of an implementation of previously described method 200, or aspects of method 300 may be used in combination with aspects of method 200. In the example depicted in FIG. 3, method 300 is performed by a computing system (e.g., a customer relationship system) that includes a wireless communication device, a local computing system including a wireless access point device, and a remote computing system. The computing system may include a plurality of wireless communication devices and/or a plurality of local computing systems that each include one or more respective wireless access point devices. Each local computing system is located at and serves a respective premises of a respective public accommodation via one or more wireless access point devices.

At 310, the wireless communication device transmits one or more wireless beacon frames. Each wireless beacon frame contains an identifier of the wireless communication device. As previously described, an identifier of a wireless communication device may be a MAC address or other suitable identifier, and the wireless beacon frames may be communicated using Wi-Fi/802.11 or other suitable wireless communications protocol.

At 320, the local computing system receives, via the wireless access point device, one or more wireless beacon frames transmitted by the wireless communication device at 310. Additionally, at 320, the local computing system may receive, via the wireless access point device, one or more wireless beacon frames transmitted by one or more additional wireless communication devices. Hence, the local computing system may receive a plurality of wireless beacon frames transmitted by a plurality of wireless communication devices carried or otherwise operated by respective users. Additionally, at 320, the local computing system may receive, via one or more additional wireless access point devices of the local computing system, one or more beacon frames transmitted by one or more wireless communication devices. The beacon frames received via the one or more additional wireless access point devices may include the same one or more beacon frames transmitted at 310 and received at 320 and/or may include one or more different beacon frames transmitted by the wireless communication device that transmitted the beacon frames at 310 and/or one or more additional beacon frames transmitted by one or more additional wireless communication devices.

At 322, the local computing system extracts the identifier of the wireless communication device from the one or more wireless beacon frames received at 320.

At 324, the local computing system, upon satisfaction of one or more rules of a rule set, determines that a user of a user account associated with the wireless communication device has visited the premises of the public accommodation served by the wireless access point device. The local computing system may perform operation 324 for each beacon frame or each unique beacon frame received at 320. Hence, operation 324 may be performed for each wireless communication device that transmits a beacon frame that is received by the local computing system via one or more wireless access point devices.

In at least some implementations, the local computing system applies the rule set to one or more attributes of the one or more wireless beacon frames to determine that or whether a user of a user account associated with a wireless communication device has visited a premises of a public accommodation that is served by a wireless access point device. As previously discussed, the one or more attributes of the one or more wireless beacon frames may include a signal strength of the one or more wireless beacon frames containing the same identifier and/or a quantity of the one or more wireless beacon frames received within a time period containing the same identifier. As also previously discussed, the one or more rules of the rule set are satisfied if: (1) a signal strength of a given beacon frame attains or exceeds a first signal strength threshold, and/or (2) a signal strength of a plurality of beacon frames containing the same identifier attains or exceeds a second signal strength threshold for at least a first threshold time period, and/or (3) a signal strength of a plurality of beacon frames containing the same identifier is substantially constant for at least a second threshold time period, and/or (4) a quantity of the one or more wireless beacon frames containing the same identifier received within a time period attain or exceed a threshold quantity of beacon frames. These one or more rules (or other suitable rules) may be applied alone or in any suitable combination to attributes of one or more wireless beacon frames containing a particular identifier. These rules may be applied on an individual identifier basis to determine whether a wireless communication device identified by that individual identifier is sufficiently present at a premises.

At 326, upon determining that the user of the user account associated with the wireless communication device has visited the premises, the local computing system initiates transmission of one or more reporting messages directed to the remote server system via a communications network. The one or more reporting messages indicate that the user account associated with the wireless communication device has visited the premises. Initiating transmission of a reporting message may include the wireless access point device instructing the one or more other local computing devices of the local computing system to transmit the reporting message. In some implementation, the reporting message may be transmitted or otherwise initiated even if the user and its wireless communication device is determined to be not present or not sufficiently present at the premises. In such case, the reporting message may indicate whether the user account/wireless communication device has been validated as being present at the public accommodation.

At 340, the remote server system maintains a visit counter associated with the user account in a database system to provide a user-specific value of a quantity of visits by the user. The user account of the database system maintained by the remote computing system may be one of a plurality of user accounts for respective users, each having a respective wireless communication device. Hence, the database system maintained by the remote computing system provides respective user-specific values of a quantity of visits by each respective user. For an identifier of a wireless communication device of first impression, the remote server system (or local server system) may create or register a user account with an associated user account identifier for that wireless communication device as identified by the identifier contained in the wireless beacon frames, and may initialize the visit counter to reflect a first visit to the premises.

In at least some implementations, the visit counter maintained by the remote server system is further associated with a premises account in the database system to provide a premises-specific value of a quantity of visits by each user to the premises of the public accommodation. The premises account may be indicated by the one or more reporting messages transmitted or otherwise initiated by a local computing system. Here, the database system maintained by the remote server system provides respective premises-specific values of a respective quantity of visits by each user to each of the respective premises as detected by each of the plurality of wireless access point devices. Hence, the database system in this implementation provides a visit count on a per user account and per premises account basis such that a visit value is maintained for each user with respect to each premises.

Furthermore, in at least some implementations, the visit counter maintained by the remote server system is further associated with a wireless access point account in the database system to provide a wireless access point-specific value of a quantity of visits by the user to the premises as detected by the local computing system via that particular wireless access point device. The wireless access point account may be indicated by the one or more reporting messages transmitted or otherwise initiated by a local computing system that includes that wireless access point device. Here, the database system provides respective wireless access point-specific values of a quantity of visits by the user to each of the respective premises as detected via each of the plurality of wireless access point devices by a respective local computing system of the respective premises. Hence, the database system in this implementation provides a visit count on a per user account and per wireless access point account basis such that a visit value is maintained for each user with respect to each wireless access point device by which that user's wireless communication device was detected. In the case of contemporaneously received wireless beacon frames at two or more wireless access point devices that were transmitted by the same wireless communication device, the remote computing system may resolve these contemporaneously received wireless beacon frames and/or identifiers thereof as constituting a single wireless beacon frame and/or identifier event.

At 342, the remote server system receive the one or more reporting messages that were transmitted at 326. Additionally, the remote server system may receive one or more additional reporting messages that were transmitted or otherwise initiated by the local computing system upon determining that one or more additional users have visited the premises. Additionally or alternatively, the remote server system may receive one or more additional reporting messages that were transmitted or otherwise initiated by one or more additional local computing systems that are located at and serve one or more additional premises.

At 344, the remote computing system augments the visit counter associated with the user account (and each other user account) indicated by the one or more reporting messages received from the local computing system (and each other local computing system) to obtain an updated visit counter that reflects that the user of that user account has visited the premises.

At 346, the remote computing system initiates transmission of one or more personalized messages directed to a contact address associated with the user account. The one or more personalized messages contain personalized information that is based, at least in part, on the updated visit counter for that user account. The remote computing system may initiate transmission of one or more personalized messages for each contact address associated with a user account that had a visit counter augmented at 344 responsive to detection of the user of that user account being present at a premises.

In at least some implementations, the remote computing system programmatically generates the personalized message information based, at least in part, on the updated visit counter. The remote computing system may programmatically generate the personalized message information further based upon a past purchase history of the user. The past purchase history of the user may be associated with the user account in the database system maintained by the remote computing system. The personalized message information may include one or more of a recommended or promotional product or service available for purchase at the premises. Other examples of personalized message information is described with reference to method 200 of FIG. 2.

In at least a first implementation, the remote computing system initiates transmission of the one or more personalized messages directed to a contact address by transmitting the one or more personalized messages to the local computing system for transmission onward to the wireless communication device via a wireless access point device of the local computing system. In at least a second implementation, the remote computing system initiates transmission of the one or more personalized messages directed to the contact address by transmitting an approval message to the local computing system. Here, the local computing system, responsive to receiving the approval message, programmatically generates the personalized message information at the local computing system, and transmits one or more personalized messages containing the personalized message information to the wireless communication device via a wireless access point device. In these implementations, the local computing system receives the one or more personalized messages or approval messages at 328, and initiates or forwards transmission of the one or more personalized messages to the wireless communication device at 330.

In at least a third implementation, the remote computing system initiates transmission of the one or more personalized messages directed to a contact address by transmitting the one or more personalized message to the wireless communication device via a different wireless network than provided by one or more wireless access points of the local computing system. Here, the different wireless network may include a wide area cellular wireless network operated by a third-party. Such communications may bypass the local computing system or may utilize the wireless access point device of the local computing system for connectivity to the wireless communication device. In the various implementations described above, the contact address may include the user account identifier, the identifier of the wireless communication device contained in the beacon frames transmitted by the wireless communication device, an email address, a telephone number of the wireless communication device, or other suitable contact address.

At 312, the wireless communication device receives the one or more personalized messages including the personalized information. At 314, the wireless communication device presents the personalized information to the user, such as by displaying the personalized information via a graphical display device of the wireless communication device.

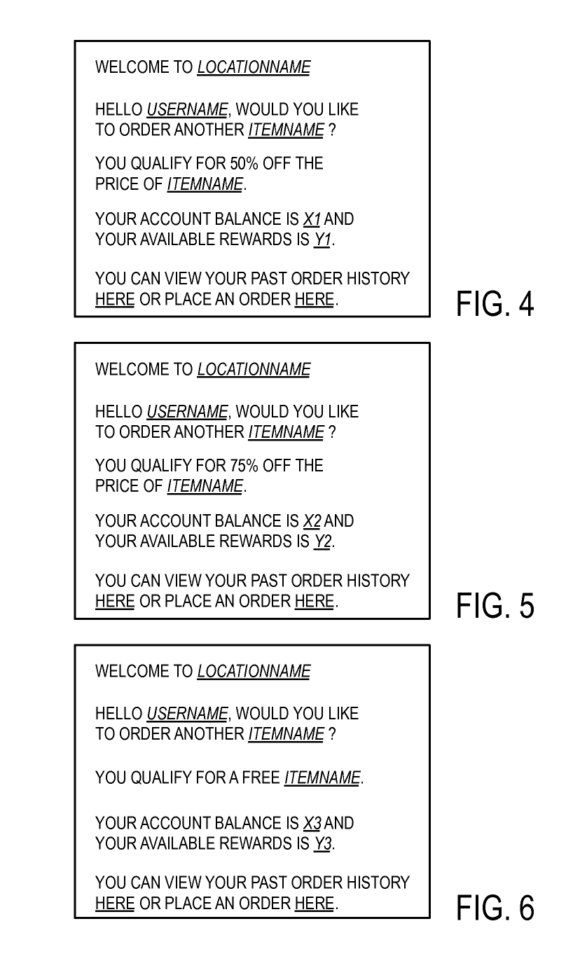

FIGS. 4-6 depict example personalized messages that may be transmitted to and presented at a wireless communication device. The example personalized messages of FIGS. 4, 5, and 6 each include one or more of the name of the public accommodation (i.e., LOCATIONNAME), the name of the user/customer (i.e., USERNAME), a suggested order (e.g., ITEMNAME) or information on the availability of a product or service (e.g., ITEMNAME), a promotional offer in relation to product or service (e.g., 50% off, 65% off, or free), a summary of a customer relationship account status including an account balance (e.g., X1, X2, X3) and/or available rewards (e.g., Y1, Y2, Y3), a link to access an order history of the user, and/or a link to an ordering tool for placing an order. The differences between the personalized messages of FIGS. 4, 5, and 6 may be based on a value of a visit counter, a user's past order history, an identity of the public accommodation, and/or other suitable factors or considerations.

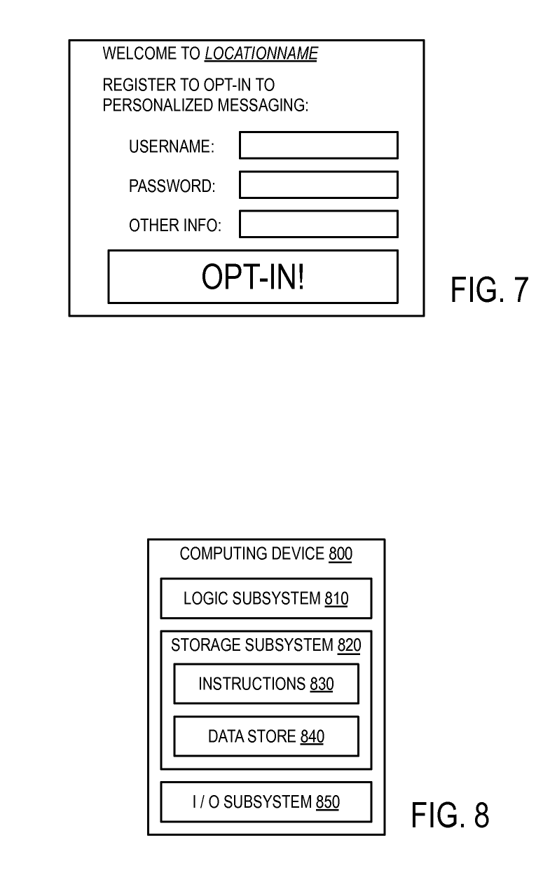

FIG. 7 depicts an example user interface that enables a user to opt-in to receiving personalized messages in accordance with the present disclosure. The example user interface of FIG. 7 may be presented at a mobile device via a browser program when the mobile device connects to or attempts to connect to a wireless network (e.g., a Wi-Fi network) at or within a public accommodation. In one example, a captive portal may be served to the mobile device of the user with an opt-in interface from the Wi-Fi access point. A user selection to opt-in may be received via the opt-in interface to establish an account for the user and to associate the MAC address and/or hardware identifier of the mobile device with the user's account. The user's account may be stored at the on-premises computing system and/or at the remote computing system. In some implementations, the opt-in interface may prompt the user to provide a variety of information as part of a user account registration process, such as a username, password, and/or other suitable information. The user may select to opt-in and/or create the user account by selecting an on-screen button or selector, such as “OPT-IN!”, for example. It will be appreciated that the user interface of FIG. 7 depicts a non-limiting example of an interface through which a user may opt-in to personalized messaging, register for a loyalty program, and/or create a user account. Other suitable interfaces may be used to obtain establish a user account and/or obtain a responses from a user to opt-in to the personalized messaging disclosed herein.

As previously discussed, the above described methods and processes may be tied to a computing system including one or more computing devices. In particular, the methods and processes described herein may be implemented as one or more applications, services, application programming interfaces, computer libraries, and/or other suitable computer programs or instruction sets.

FIG. 8 is a schematic diagram depicting an example computing device 800 that may perform one or more of the above described methods and processes. Computing device 800 is shown in simplified form. It is to be understood that virtually any computer architecture may be used without departing from the scope of this disclosure. Computing device 800 or portions thereof may take the form of one or more of a mainframe computer, a server computer or server system, a computing device residing on-board a vehicle, a desktop computer, a laptop computer, a tablet computer, a home entertainment computer, a network computing device (e.g., a WAP device), a mobile computing device, a mobile communication device, a wireless communication device, a gaming device, a wearable computing device, etc. In the context of a server system, computing device 800 may take the form of one or more server devices that are co-located at a common location or geographically distributed across two or more locations.

Computing device 800 includes a logic subsystem 810 and a computer readable information storage subsystem 820. Computing device 800 may further include an input/output subsystem 850. Logic subsystem 810 includes one or more physical, tangible devices configured to execute instructions, such as example instructions 830 held in storage subsystem 820. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 810 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 820 includes one or more physical, tangible, non-transitory, devices configured to hold data in data store 840 and/or instructions 830 executable by the logic subsystem to implement the herein described methods and processes. When such methods and processes are implemented, the state of storage subsystem 820 may be transformed (e.g., to hold different data or other suitable forms of information).

Storage subsystem 820 may include removable media and/or built-in devices. Storage subsystem 820 may include optical memory devices (e.g., CD, DVD, HD-DVD, Blu-Ray Disc, etc.), semiconductor memory devices (e.g., FLASH, RAM, EPROM, EEPROM, etc.) and/or magnetic memory devices (e.g., hard disk drive, floppy disk drive, tape drive, MRAM, etc.), among others. Storage subsystem 820 may include devices with one or more of the following characteristics: volatile, nonvolatile, dynamic, static, read/write, read-only, random access, sequential access, location addressable, file addressable, and content addressable. In at least some implementations, the logic subsystem and storage subsystem may be integrated into one or more common devices, such as an application specific integrated circuit or a system on a chip.

It is to be appreciated that storage subsystem 820 includes one or more physical, non-transitory devices. In contrast, in at least some implementations and under select operating conditions, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module” or “program” may be used to describe an aspect of a computing device that is implemented to perform one or more particular functions. In some cases, such a module or program may be instantiated via logic subsystem 810 executing instructions held by storage subsystem 820. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” or “program” are meant to encompass individual or groups of executable files, data files, libraries, drivers, scripts, database records, etc. Examples of software include an operating system, an application program such as the previously described authoring application program and/or viewer application program, a plug-in, a software update, a software portion, or combinations thereof.

It is to be appreciated that a “service”, as used herein, may be an application program or other suitable instruction set executable across multiple sessions and available to one or more system components, programs, and/or other services. In at least some implementations, a service may run on a server or collection of servers responsive to a request from a client.

Input/output subsystem 850 may include and/or otherwise interface with one or more input devices and/or output devices. Examples of input devices include a keyboard, keypad, touch-sensitive graphical display device, touch-panel, a computer mouse, a pointer device, a controller, an optical sensor, a motion and/or orientation sensor (e.g., an accelerometer, inertial sensor, gyroscope, tilt sensor, etc.), an auditory sensor, a microphone, etc. Examples of output devices include a graphical display device, a touch-sensitive graphical display device, an audio speaker, a haptic feedback device (e.g., a vibration motor), etc. When included, a graphical display device may be used to present a visual representation of data held by the storage subsystem. As the herein described methods and processes change the data held by the storage subsystem, and thus transform the state of the storage subsystem, the state of the graphical display may likewise be transformed to visually represent changes in the underlying data.

Input/output subsystem 850 may further include a communication subsystem that is configured to communicatively couple computing device 800 with one or more other computing devices or computing systems. The communication subsystem may include wired and/or wireless communication devices compatible with one or more different communication protocols. As an example, the communication subsystem may be configured for communication via a wireless telephone network, a wireless local area network, a wired local area network, a wireless personal area network, a wired personal area network, a wireless wide area network, a wired wide area network, etc. In at least some implementations, the communication subsystem may enable the computing device to send and/or receive messages to and/or from other devices via a communications network such as the Internet, for example.

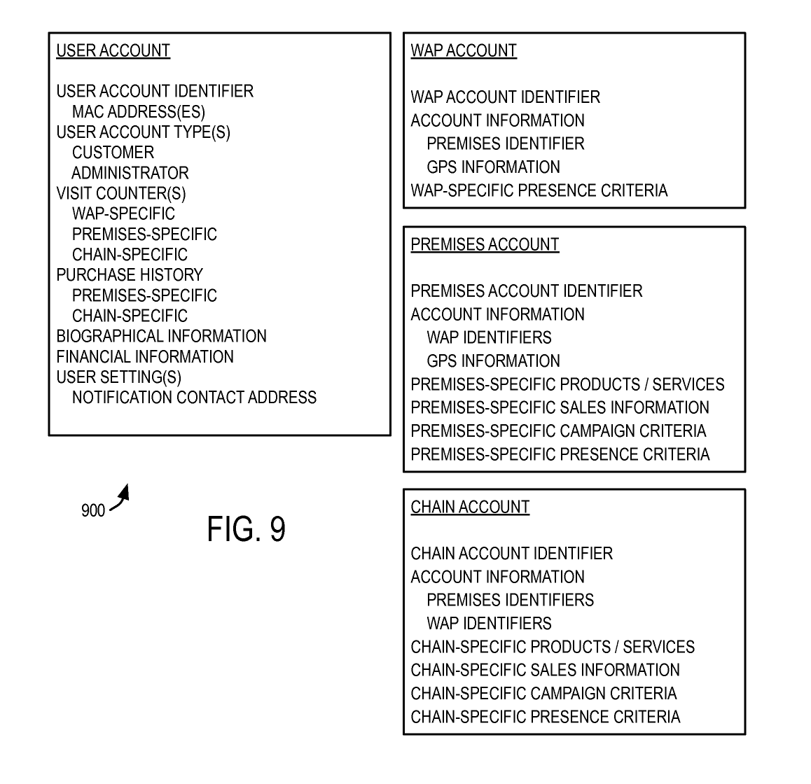

FIG. 9 is a schematic diagram depicting example data records 900 that may be contained in an example database system. As one example, data records 900 may form part of a database system maintained at a remote computing system and/or at a local computing system as previously described.

Data records 900 includes a customer relationship record in the form of a USER ACCOUNT for each user that may be associated with the following information: a USER ACCOUNT IDENTIFIER for the user account; one or more MAC ADDRESS(ES) of one or more wireless communication device associated with the user account identifier; one or more USER ACCOUNT TYPE(S) including a CUSTOMER type of user account and/or an ADMINISTRATOR type of user account; one or more VISIT COUNTER(S) for that user account which may be additionally WAP-SPECIFIC (i.e., on a per wireless access point device basis), PREMISES-SPECIFIC (i.e., on a per premises basis for each public accommodation), and/or CHAIN-SPECIFIC (i.e., on a per chain basis across all premises of each chain); a PURCHASE HISTORY associated with the user account which may be additionally PREMISES-SPECIFIC (i.e., on a per premises basis for each public accommodation) and/or CHAIN-SPECIFIC (i.e., on a per chain basis across all premises of each chain); BIOGRAPHICAL INFORMATION of the user of the user account; FINANCIAL INFORMATION which may be used to facilitate a financial transaction by a user at a premises for a product or service available for purchase at the premises; one or more USER SETTING(S) which may include any suitable user-defined setting, such as user preferences; NOTIFICATION CONTACT ADDRESS which may correspond to a define or preferred contact address associated with the user account and/or wireless communication device. It will be appreciated that a user account may be associated with other suitable forms of information.

Data records 900 includes a WAP ACCOUNT for each wireless access point device that may be associated with the following information: WAP ACCOUNT IDENTIFIER of the wireless access point device; ACCOUNT INFORMATION may include or be associated with a PREMISES IDENTIFIER for a premises served by and at which the wireless access point device is located, and/or GPS INFORMATION (e.g., geospatial coordinate values) defining a geographic location of the wireless access point device or region of wireless service provided by the wireless access point device; WAP-SPECIFIC PRESENCE CRITERIA which may include a rule set for detecting presence that is specific to the wireless access point device. It will be appreciated that a WAP account may be associated with other suitable forms of information.

Data records 900 includes a PREMISES ACCOUNT for each premises of a public accommodation that may be associated with the following information: a PREMISES

ACCOUNT IDENTIFIER of the premises; ACCOUNT INFORMATION of the premises including one or more WAP IDENTIFIER(S) of one or more wireless access points located at and serving the premises, and/or GPS INFORMATION (e.g., geospatial coordinate values) defining a geographic location or region of the premises; PREMISES-SPECIFIC PRODUCTS/SERVICES which may include current inventory, cost information, specials, offers, recommended products or services, etc. for the premises; PREMISES-SPECIFIC SALES INFORMATION which may include historical sales records of the premises; PREMISES-SPECIFIC PRESENCE CRITERIA which may include a rule set for detecting presence that is specific to the premises and all WAPs of the premises; PREMISES-SPECIFIC CAMPAIGN CRITERIA which may include a rule set for generating personalized information for the premises and all WAPs of the premises. It will be appreciated that a premises account may be associated with other suitable forms of information.

Data records 900 includes a CHAIN ACCOUNT for each chain of related public accommodations that may be associated with the following information: a CHAIN ACCOUNT IDENTIFIER of the chain of premises; ACCOUNT INFORMATION of the chain including one or more PREMISES IDENTIFIER(S) associated with the chain and/or one or more WAP IDENTIFIER(S) associated with the chain; one or more CHAIN-SPECIFIC PRODUCTS/SERVICES which may include current inventory, cost information, specials, offers, recommended products or services, etc. for the chain; CHAIN-SPECIFIC SALES INFORMATION which may include historical sales records of the chain and all of its premises; CHAIN-SPECIFIC PRESENCE CRITERIA which may include a rule set for detecting presence that is specific to the chain and all premises and WAPs of the chain; CHAIN-SPECIFIC CAMPAIGN CRITERIA which may include a rule set for generating personalized information for the chain and all premises and WAPs of the chain. It will be appreciated that a chain account may be associated with other suitable forms of information.

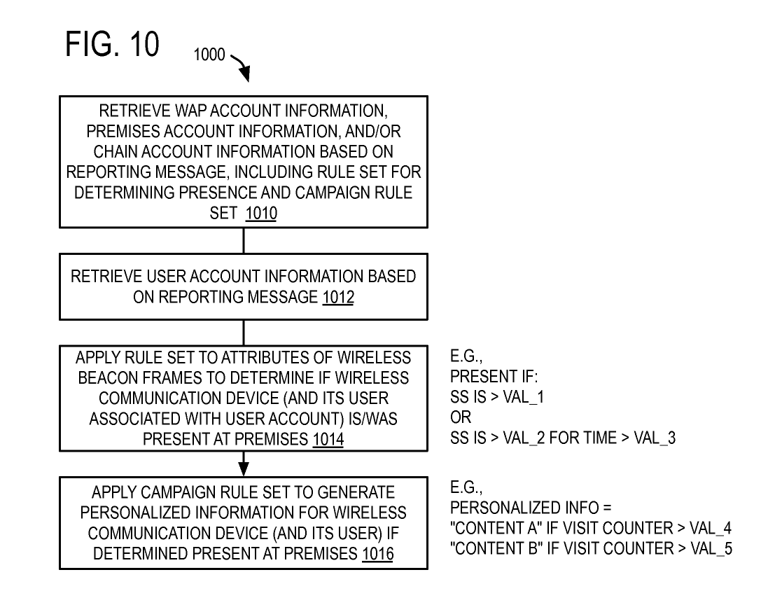

FIG. 10 is a flow diagram depicting an example method 1000 of applying rule sets to generate personalized information. Method 1000 may be performed by the remote computing system and/or local computing system of FIG. 1, for example.

At 1010, the method includes retrieving account information for the WAP, the premises, and/or the chain attributed to detection of the wireless beacon frames of the wireless communication device. At 1012, the method includes retrieving user account information for the user associated with the identifier of the wireless communication device. At 1014, the method includes applying the rule set for presence with respect to the WAP, premises, and/or chain obtained from the information retrieved at 1010 to the attributes of the wireless beacon frames to determine if the wireless communication device (and its user associated with the user account) is or was present at the premises. FIG. 10 depicts a simplified non-limiting example of a rule set for detecting presence as: the wireless communication device is determined to be present if the signal strength (SS) of the wireless beacon frame(s) is >a threshold value (VAL_{—}1) or the signal strength is >a second threshold value (VAL_{—}2) (e.g., less than VAL_{—}1) for a time that exceeds a third threshold value (VAL_{—}3). 1016, the method includes applying the campaign rule set with respect to the WAP, premises, and/or chain obtained from the information retrieved at 1010 to generate the personalized information for the wireless communication device (and its user) if determined at 1014 to be present at the premises. FIG. 10 depicts a simplified non-limiting example of a campaign rule set for generating personalized information as: the personalized information (PERSONALIZED INFO) equaling content “CONTENT A” if the visit counter is greater than a fourth value (VAL_{—}4) and equaling content “CONTENT B” if the visit counter is greater than a fifth value (VAL_{—}5) (e.g., which is different than VAL_{—}4). Content in the form of “CONTENT A” and “CONTENT B” may be based at least in part on the user account information retrieved at 1012, as previously discussed with reference to FIGS. 2-6.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A method performed by a computing system, the method comprising:
at a local computing system located at and serving a premises of a public accommodation:
receiving via a wireless access point device, one or more wireless beacon frames transmitted by a wireless communication device, the one or more wireless beacon frames containing an identifier of the wireless communication device,
extracting the identifier of the wireless communication device from the one or more wireless beacon frames,
applying a rule set to one or more attributes of the one or more wireless beacon frames to, upon satisfaction of one or more rules of the rule set, determine that a user of a user account associated with the wireless communication device has visited a premises of a public accommodation served by the wireless access point device,
the one or more attributes including:
signal strength of the one or more wireless beacon frames, and/or
quantity of the one or more wireless beacon frames received within a time period,
the one or more rules of the rule set being satisfied if:
the signal strength attains or exceeds a first signal strength threshold,
the signal strength attains or exceeds a second signal strength threshold for at least a first threshold time period,
the signal strength is substantially constant for at least a second threshold time period, and/or
the quantity of the one or more wireless beacon frames received within the time period attains or exceeds a threshold quantity of beacon frames,
upon determining that the user of the user account associated with the wireless communication device has visited the premises, initiating transmission of one or more reporting messages directed to a remote server system via a communications network, the one or more reporting messages indicating the user account associated with the wireless communication device; and
at the remote server system:
maintaining a visit counter associated with the user account in a database system to provide a user-specific value of a quantity of visits by the user,
receiving the one or more reporting messages,
augmenting the visit counter associated with the user account indicated by the one or more reporting messages received from the to obtain an updated visit counter that reflects that the user of the user account has visited the premises, and
initiating transmission of one or more personalized messages directed to a contact address associated with the user account, the one or more personalized messages containing personalized information that is based, at least in part, on the updated visit counter.

2. The method of claim 1, wherein the visit counter maintained by the remote server system is further associated with a premises account in the database system to provide a premises-specific value of a quantity of visits by the user to the premises of the public accommodation, the premises account further indicated by the one or more reporting messages.

3. The method of claim 2, wherein the wireless access point device is one of a plurality of wireless access point devices, each located at and serving a respective premises of a public accommodation; and
wherein the database system maintained by the remote server system provides respective premises-specific values of a respective quantity of visits by the user to each of the respective premises as detected by each of the plurality of wireless access point devices.

4. The method of claim 1, wherein the visit counter maintained by the remote server system is further associated with a wireless access point account in the database system to provide a wireless access point-specific value of a quantity of visits by the user to the premises as detected by the local computing system via the wireless access point device, the wireless access point account further indicated by the one or more reporting messages.

5. The method of claim 4, wherein the wireless access point device is one of a plurality of wireless access point devices, each located at and serving a respective premises of a public accommodation; and
wherein the database system provides respective wireless access point-specific values of a quantity of visits by the user to each of the respective premises as detected via each of the plurality of wireless access point devices by a respective local computing system of the respective premises.

6. The method of claim 1, wherein the user account is one of a plurality of user accounts for respective users, each having a respective wireless communication device; and
wherein the database system provides respective user-specific values of a quantity of visits by each respective user.

7. The method of claim 1, further comprising:
programmatically generating the personalized message information based, at least in part, on the updated visit counter, and further based on a past purchase history of the user, the past purchase history of the user being associated with the user account in the database system; and
wherein the personalized message information includes one or more of a recommended or promotional product or service available for purchase at the premises.

8. The method of claim 1, wherein the identifier of the wireless communication device is a MAC address.

9. The method of claim 1, wherein initiating transmission of the one or more personalized messages directed to the contact address includes transmitting the one or more personalized messages to the local computing system for transmission to the wireless communication device.

10. The method of claim 1, wherein initiating transmission of the one or more personalized messages directed to the contact address includes transmitting an approval message to the local computing system; and
wherein the method further comprises, responsive to receiving the approval message at the local computing system, programmatically generating the personalized message information at the local computing system, and transmitting the one or more personalized messages containing the personalized message information to the wireless communication device via the wireless access point device.

11. A customer relationship system, comprising:
a relationship server connected to a computer network;
a wireless access point device located in a public accommodation and connected to the computer network, the wireless access point device configured to:
detect a plurality of beacon frames transmitted by each of a plurality of wireless communication devices;
identify a MAC address of each of the wireless communication devices from the beacon frames originating therefrom;
validate that a target wireless communication device of the plurality of wireless communication devices associated with a respective MAC address was present at the public accommodation by matching an on-premises characteristic; and
transmit a message to the relationship server via the computer network indicating the target wireless communication device was detected at the wireless access point device and validated as matching the on-premises characteristic;
wherein the relationship server is configured to:
maintain a customer relationship record for the target wireless communication device, the customer relationship record including a visit counter for the wireless access point device at the public accommodation;
augment the visit counter for the wireless access point device at the public accommodation based upon the message received from the wireless access point device;
store the augmented visit counter in the customer relationship record, the customer relationship record accessible to the relationship server based on the detected presence of the target wireless communication device; and
transmit a personalized message to the target wireless communication device, the personalized message being programmatically modified based upon the value of the visit counter.

12. The customer relationship system of claim 11, wherein the on-premises characteristic includes a signal strength of the beacon frames being greater than a predetermined signal strength threshold.

13. The customer relationship system of claim 11, wherein the on-premises characteristic includes a plurality of successive beacon frames having the same MAC address being detected over a period of time that is greater than a predetermined time threshold.

14. The customer relationship system of claim 11, wherein the on-premises characteristic includes a plurality of beacon frames having the same MAC address being detected as having a substantially constant signal strength value over at least a predetermined time threshold.

15. The customer relationship system of claim 11, wherein the wireless access point device is one of a plurality of wireless access point devices, each located in a respective public accommodation and connected to the computer network, each wireless access point device being configured to:
detect a plurality of beacon frames transmitted by each of the plurality of wireless communication devices; and
identify a MAC address of each wireless communication device of the plurality of wireless communication devices from the plurality of beacon frames;
validate that one of the wireless communication devices associated with one of the MAC addresses was present at the respective public accommodation associated with the wireless access point device by matching an on-premises characteristic; and
transmit a message to the relationship server via the computer network indicating the wireless communication device was detected at the wireless access point device and validated as matching the on-premises characteristic; and
wherein the visit counter in the customer relationship record for the wireless communication device is one of a plurality of visit counters, each visit counter counting visits to a one of the wireless access point devices at a corresponding public accommodation.

16. The customer relationship system of claim 1, wherein the personalized message includes information on the availability of a product or service in the public accommodation frequented most often by the user according to data contained in the customer relationship record.

17. The customer relationship system of claim 1, wherein the customer relationship system receives GPS data indicating a detected location of the target wireless communication device, and wherein the personalized message includes information relating to a product or service of a public accommodation nearby the detected location.

18. The customer relationship system of claim 1, wherein the personalized message includes:
a summary of a customer relationship account status, including account balances and available rewards, and/or
a link to access an order history of the user.

19. The customer relationship system of claim 1, wherein the personalized message includes a suggested order for the user, wherein the suggested order is based upon (1) order history, (2) express user-defined preferences, (3) actual sales of goods and services at the public accommodation, and (4) a link to an ordering tool.
